(19) United States
(12) Patent Application Publication
(10) Pub. No.: US 2002/0178696 A1
(43) Pub. Date: Dec. 5, 2002

(54) Device for locating and retrieving small articles

(76) Inventor: W.G. Don Korff, Sylmar, CA (US)

Correspondence Address: W.G. DON KORFF, 13774 ELDRIDGE AVE., SYLMAR, CA, 91342, US

(21) Appl. No.: 09/837,317

(22) Filed: Apr. 19, 2001

(51) Int. Cl. B01D 50/00

(52) U.S. Cl. 55/337

(57) ABSTRACT

A vacuum operated device for locating and retrieving small hard-to-see articles that have been dropped or lost within an area of known limits. By vacuum cleaning the entire area, the retrieval device will capture and entrap all items of a predetermined size or greater, but prevent them from passing through to the vacuum cleaning system's debris collection bag or reservoir. At the same time, smaller dust and dirt particles are allowed to pass through freely. The recovered articles are trapped within a small, transparent jar like chamber, where they are readily observed, and from which they are easily ejected without the need to disassemble the device. Large dirt and debris particles which also accumulate within the chamber are purged by simply switching the device to the appropriate operating position.

### BACKGROUND

1. Field of Invention

This invention relates to a method and apparatus for locating and retrieving one or more small, “hard to see articles” which have been lost or misplaced within a certain area, and in particular to a method and apparatus that utilizes a standard vacuum cleaning system as the motive force for that task.

2. Prior Art

Heretofore, devices for finding and retrieving small articles have included the deployment of magnetic attraction, which limits the expectation of successful recovery only to items containing ferrous materials.

There also exist vacuum operated retrieval devices capable of filtering the air stream and thus preventing non-ferrous articles from passing through (U.S. Pat. Nos. 2,293,920 and 2,354,089 Repogle; U.S. Pat. No. 2,467,652 Beede; U.S. Pat. No. 4,833,753 Muller; U.S. Pat. No. 5,375,293 Gilbertson). However, because they are intended for a general sampling or sifting of the air stream, with the goal of simply intercepting whatever may turn up, rather than to search for a specific article or articles, known by the user to be of certain size, and within an area of known limits, such devices are not capable of performing completely thorough, reliable and satisfactory searches due to having a number of deficiencies. Noteworthy among these are:

Disassembly and manual cleaning is required to purge debris from filter elements (Repogle, Beede, Gilbertson).

Secondary filters, when installed, do not cancel out the effect of the primary filter, but act in concert with it, thus debris build-up continues unabated. To change to another filter size, tedious and time-consuming disassembly is required. (Muller)

The absence of positive means for holding trapped articles securely within the device, unless the suction tube is maintained in a horizontal or near horizontal position, whereas a near vertical position is much more natural when employing a vacuum wand for most cleaning applications.

The necessity to partially disassemble the device in order to eject the trapped articles.

### BACKGROUND

### Basic Problems To be Solved

For the purpose of this description, and to fully comprehend and appreciate the merits of this invention, the term “small article” or simply “article”, is defined as encompassing a variety of unrelated solid and semi-solid objects, any of which fall in a size range where the smallest is on the threshold of being visibly discerned by those with the best eyesight, and where the largest is limited in size and weight only to the size of the inlet aperture of the device and to the available suction force of the vacuum system utilized. To further define “article”, it can consist of any known material or combination of materials, natural or manmade, and be of any shape and density whatsoever. Furthermore, it can be of any color or absence of color, and of any surface condition, such as smooth, rough, textured, hard or soft, hot or cold.

The need for timely recovery of such an article is proportionate not only to its intrinsic value, but often more so to its inherent importance and to the fact that it may be irreplaceable due to its own unique purpose or function, or to the urgency of the users reliance upon it at the time of its disappearance.

These aspects are most readily understood when evaluating some typical examples:

### Household, Business and General Situations

Jewelry: earrings, gemstones, beads, pearls, etc. (Monetary, sentimental value) Pendants, chain links, loops, hooks, buttons, (Needed to repair, restore jewelry) Contact lenses (In the absence of which the user is partially incapacitated) Prescription pills (Urgently needed, yet replenishments not readily obtainable) Tooth or tooth fragments, natural or denture (Needed to repair) Miniature hardware: screws, nuts, washers, (Needed to finish urgent tasks) Broken fragments of damaged valuables (Needed to reconstruct) Small valuables recovered from cars in a car wash

### Commercial or Industrial Situations

Special fasteners and components used in the assembly of products, such as Screws, nuts, washers, rivets, pins, steel balls, O-rings, gaskets: Electronic parts: microchips, resistors, diodes, condensers, IC's: Miniature components, such as gears, springs, clamps and the like.

### Losing Small Valuables

Often such a small article accidentally drops onto the floor or some kind of work surface, or somewhere inside of a car, or on a sofa, bed and other furniture, and in various other areas too numerous to foresee. If the floor is carpeted, and the article happens to be of certain prerequisite dimensions, unique shape and texture, it may sink below the surface of the nap, so as to completely disappear from sight. If the floor is hard (hardwood, tile, linoleum, concrete or the like), the article may bounce, roll or slide a considerable distance from the drop point, and in a direction not always observed. It may come to rest behind or beneath an obstruction, lodge in a crevice, or simply blend in with the surface. Depending on the type, size, color and other outwardly observable characteristics of the article, as well as on the eyesight of the person(s) looking for it, any of the scenarios described here by way of example can make it extremely difficult and time consuming, if not impossible, to find and recover such an article by merely scanning the surrounding area visually.

Sometimes the absence of an article lost in this context is not necessarily discovered at the moment of its disappearance, but may become known only after a passage of time. In such a case, mental recollection and deduction may lead to defining an area suspected of containing the lost article, and the dimensional limits of that suspected area are usually much greater than they would have been, had the loss of the article been noticed at the time of its disappearance. Here a visual inspection alone would obviously take even more time and effort, while at the same time being less likely to yield a positive result.

The task of locating a dropped article is made even more difficult if it falls onto a surface already covered with a dense layer of particulate matter, such as dirt, sand, stone pebbles, sawdust, concrete mix, flour or any kind of granular or powdery substance. In such cases the fallen article may end up being buried somewhere below the surface of such particulate matter, making visual locating all but impossible. Unless the area to be searched is relatively small, and the lost article relatively large in proportion to the granular matter, manual sifting by hand or with the help of sieves or screens may prove to be unacceptably cumbersome and time consuming.

### Primary Object

Accordingly, it is an object of this invention to provide a method and apparatus for quickly locating and retrieving any article of the kind described above, and lost under circumstances similar to those cited herein, without having to know its exact location, by searching the general area known to contain the lost article, until it is found. The method consists of the well known procedure of vacuum cleaning, utilizing any standard vacuum cleaning system in widespread existence in households, commercial, industrial and institutional establishments. The apparatus consists of a retrieval device which is adaptable mounted between whatever intake nozzle the user wishes to employ and the vacuum cleaner unit itself, and is so configured as to prevent the sought article, once intercepted, from being sucked into the system's debris receptacle, be that a filter bag, a bag-less reservoir, or a large drum, such as those used in central cleaning systems.

### Dealing With Debris

Isolating the captured article from other debris picked up prior to and during the recovery process, such as dust, lint, hair, etc. not only improves its chances of being discerned, but also precludes the user from having to search through masses of unsightly and unhygienic debris. Thus it is a further object of this invention to provide a “jar like see-through chamber” small enough to facilitate instant recognition of any unique object entering and oscillating within its confines, thus signaling that the sought article may have been found, and from which it may then be quickly and easily ejected. At the same time, this chamber is made large enough to permit the possible accumulation of debris, which may be collecting as an unwanted byproduct of the process. To assure that the searched for article is trapped within this chamber and thus prevented from passing on through to the main debris receptacle, a filter element is provided which, at a minimum, performs three essential functions:

A. Presents a net open area at least equal to, or greater than the area of the main inlet nozzle.

B. Presents a clear flow path to the stream of supply air, and to any particulates entrained in it which are smaller in size than the size of the smallest article ever anticipated to be captured.

C. Presents an obstacle to any article of the same size and greater than the size of the smallest article ever anticipated to be captured, as measured across its smallest profile.

Function A. assures that the volume of airflow through the system is sufficient to maintain vacuum pickup.

Function B. allows dust particles, fine powder and similar small debris to pass through without clogging the filter.

Function C. prevents any article of requisite size from passing through the system, whether or not such an article is “wanted” or “unwanted”. In this context, “unwanted” articles would include any debris present in the search area that is larger than the orifice size of the filter element, and which of necessity is also collecting in the “see-through chamber” of the device. See the later paragraph titled “Controlling Unwanted Debris” for additional information about this subject.

### Multiple Articles

In the aforementioned situations, the problems are greatly exacerbated if more than a singular small article is dropped, as can occur when a group of such items is accidentally spilled from their container; or worse yet, when the entire container housing them is dropped, in which case a large number of tiny articles may end up widely scattered all over the floor and other surfaces.

Such a spill creates an additional element of urgency and thus an even greater need to find and retrieve each one of these items immediately, for these reasons:

Unless and until they are completely recovered, the scattered articles are posing the danger of tripping and falling to all attendant personnel or to visitors arriving upon the scene after such an occurrence, with the consequent potential for personal injury, property damage, or both.

There is also the potential for causing damage to the spilled articles themselves, due to the greater likelihood they will be stepped on by nearby personnel or by visitors arriving upon the scene after such an occurrence, with the consequent potential of irreparable damage to at least some of the articles, causing financial loss, missed deadlines and other adverse effects.

Therefore, it is a further object of this invention to provide the aforementioned retrieving device having a retention capacity sufficiently proportioned, and so configured as to facilitate the capturing, secure holding, and subsequent ejection of one or a multiplicity of small articles, without substantially limiting or constraining the direction or orientation of the device during the process.

### Problems Stemming From Difficult Access

There are also instances when a dropped article is in fact clearly observed coming to rest in a certain area, yet that location is so restricted that it cannot be reached by hand, or even with normal gripping devices such as long nose pliers, tweezers, tongs or the like, so that the only practical method of retrieval is the use of suction force. Examples of this are small parts accidentally dropped into one of the many crevices of an automobile engine or other auto body areas during car repair, or into an electronic device filled with wires and other obstructing components, in short, into any narrow, hollow space normally so inaccessible as to require removal or even destruction of the surroundings to gain sufficient access. In such instances the problem is therefore not how to find the article, but how to get close enough to grip it for positive recovery, unless one uses the vacuum suction method.

Therefore, it is a still further object of this invention to provide the vacuum retrieval device previously described, in combination with long enough and thin enough rigid inlet tubes and where needed, flexible inlet tubes, capable of extending into locations otherwise too distant and/or too inaccessible to reach.

### Personal Safety Problems

Still another problem that often occurs involves the exposure to injury, namely when the fallen and scattered articles consist of sharp objects capable of causing skin cuts or punctures. Examples are broken pieces of glass, sharp pins, tacks, needles, unbent staples, and similarly dangerous small items. While their recovery is of no material value, their immediate removal from the affected area is necessary to avoid injury, especially in such places as gyms, pool decks, children's play rooms and any place frequented barefoot. And rather than to merely rely on a visual inspection of the area when purging it of such dangerous elements, it is of considerable benefit to be able to actually collect, view and even count the sharp objects immediately following their retrieval, in order to provide certainty and reassurance to all concerned.

A further advantage of collecting sharp objects by vacuum force instead of by hand is the avoidance of injury during pickup. And by capturing these foreign objects within the hard-surfaced portion of the inlet tubing, before they reach the softer, more vulnerable insides of flexible hoses, internal damage to all downstream components, including hoses, cloth or paper filters, and even the blower unit itself, is also circumvented.

Therefore, it is a still further object of this invention to provide a retrieval device for safely picking up sharp objects capable of causing personal injury and/or damage to the vacuum system, collecting them for viewing and optional counting in a see-through jar, and ejecting them safely from that jar without the need for direct contact by human hands.

### Controlling Unwanted Debris

Inasmuch as this device is intended to search for articles of such a wide size range, i.e. from something barely visible to something bigger than the size of a coin, while operating in a variety of environments, i.e. from a substantially clean hard floor to uneven surfaces strewn with all kinds of dust, dirt and debris, it is to be expected that many unwanted items as large as, and larger than the sought-after article will be picked up during the search process as well. As was explained in the foregoing paragraph “Dealing With Debris”, under Function C., the orifice size of the filter element determines which articles are allowed to pass through and which ones are stopped. Thus, if the search area contains much debris, such as granules, fibers, lint, hair etc., this will all accumulate within the see-through chamber, and if allowed to build up, will eventually clog the filter element to the point of reducing and even stopping the airflow. If the lost article has not been found by the time this occurs, it becomes necessary to purge the accumulated debris from the chamber before the search can continue. Depending on the degree of contamination of the search area, it may take several minutes to clog the filter elements, and in severe cases merely a few seconds. In either case, the necessity of periodically halting the search in order to clean the filter represents one of the major time consuming interruptions plaguing prior attempts to handle such vacuum searches. The clogging problem is exacerbated when some particles actually become lodged in the filter orifices, or when lint, fiber, hair and the like tend to partially penetrate the holes, then cling to the surface, which leads to a rapid build-up of debris on the entering side of the filter, making its removal by conventional methods problematic.

Accordingly, it is an important object of this invention to provide the vacuum operated retrieval device having a filter element and a collecting chamber, which are disposed so as to permit “self cleaning”, whereby at the option of the user, unwanted debris having collected in the chamber may be passed through to the vacuum system's debris reservoir entirely without the need to open or disassemble the device, and without the need for any direct handling whatsoever. And, in addition to evacuating the chamber, it is a still further object of this invention to provide an easy-to-use mechanism for purging the filter element of any clogged up matter, by directing the airflow in the reverse direction, so as to “back-blast” and thereby positively dislodge any jammed particles.

These self-cleaning functions are quickly and conveniently accomplished by rapid “flick-of-the-wrist” motions on the part of the user, requiring no tools, nor special skills, nor disassembly of any component. Consequently, the speed and effortless ease with which these tasks can be performed render this invention a vast improvement over prior art devices.

### Filler Element Orifice Size

The foregoing description showed that the actual filter orifice size determines on the one hand the size of the smallest article the device will capture, and on the other hand, the size of all unwanted particles it will allow to pass through. For example, if the orifices are 1 mm in diameter, any article of or in excess of 1 mm cross section would be caught, while anything smaller than 1 mm is passed through. In such a case, dust, fine granules and perhaps even fine lint and fibers can pass right through, leaving the chamber clear and unobstructed for long periods, yet any lost article 1 mm or bigger is positively captured, whereupon it will be clearly visible somewhere inside the chamber. It follows that larger orifices will capture correspondingly larger articles, while also passing larger contaminants, thus accumulating less debris. Conversely, the smaller the filter orifice size, the smaller will be the article it is capable of capturing, but at the same time, unfortunately, the greater also the likelihood of accumulating unwanted debris very quickly.

This permits a multitude of configurations of my device, each providing its own distinct relationship of capture size vs. debris tolerance, for optimum results under differing search requirements:

### Fine Filtering

A device having its filter orifices sized to intercept articles equal to or greater than, say for instance, 1/10 mm. Such a device would offer the greatest assurance for capturing almost any article imaginable, by covering the widest possible size range. But it would also become choked with debris the quickest, even in relatively clean environments. It would require the greatest number of periodic cleaning operations, at the shortest intervals, a solution made possible and easily accomplished through the unique multi-position self-cleaning means inherent in my invention.

### Medium Filtering

A device with, for instance, 1.5 mm orifices would not be called upon to capture any article quite as tiny as the former, but if properly identified, would still be highly useful for capturing a wide range of articles of that size or bigger, while allowing almost all dust and debris found in average, well maintained places of human occupation to pass through unhindered. This type would require periodic cleaning only in highly contaminated areas, or more infrequently in others.

### Coarse Filtering

A device with orifices greater than, for instance, 2 or 3 mm. Depending on the actual chosen size, such devices can be designated for specific target groups or classifications of items to be picked up, such as automotive fasteners or electronic components, as well as for sifting specific granular or fibrous substances, such as sand, pebbles, sawdust, flaky matter, grass clippings etc.

### Fine, or Medium, or Coarse Filtering

A device having the filter element removably mounted, so as to permit exchanging any element with another of desirable orifice size, thus rendering the searching device capable of handling any one of the foregoing contingencies whenever called upon to do so by the prevailing conditions. This makes my invention the most versatile of all solutions, because an endless variety of filter elements can be provided.

### Fine, and Medium, and Coarse Filtering, or Fine and Coarse Filtering

A device having a filter element with more than one orifice size directly “built-in”, and disposed so as to selectively permit the deployment of either size, at the users option, as deemed necessary by the search requirements and by the environment at hand. This combination is the most useful and efficient one, enabling the user to choose the most advantageous filtering mode with quick and convenient “flick-of-the-wrist” motion, made to “click” into any of the available positions with built-in precision.

Accordingly, it is another object of this invention to provide a vacuum operated retrieval device, including either an integrally configured or an interchangeably installed filter element incorporating varying orifice sizes, which are predetermined to be most suitable for a given minimum size of articles to be retrieved, or for a known maximum particle size of unwanted matter preferred to pass freely through the system.

Alternately, it is an object of this invention to provide a retrieval device with a simple-to-use selection mechanism, augmented by intuitive detent action, which enables the user to instantly switch, either prior to or during the vacuum searching process, from one built-in filter orifice size to another, whether for the purpose of reducing debris build-up, or for providing greater assurance of capturing the smallest possible lost article. When switching from one filter position to the other, it is important to realize that in the present invention one filter cancels out the effect of the other (e.g. A or B or C), unlike tandem arrangements of the prior art working in series (A plus B). Thus the net effect is the same as that provided by two or three independent filters.

Inasmuch as all of the above described configurations can be derived from the latter combination, it therefore constitutes the preferred embodiment of the invention, and its many advantages, and features, together with the above and other objects, will become more apparent from the following description, when taken in conjunction with the accompanying drawings.

### BRIEF DESCRIPTION OF THE DRAWINGS

FIG. 1 is an isometric view showing the present invention used in combination with typical vacuum cleaning systems.

FIG. 2 is an enlarged isometric view showing the invention used with various types of suction nozzles.

FIG. 3 is an isometric view showing a multiplicity of complements of this invention installed on a vacuum manifold.

FIG. 4 is an isometric exploded view of the invention.

FIG. 5 is a front view, with some of the components partially cut away for clarity.

FIG. 5A is a sectional view taken along the line 5A-5A of FIG. 5, looking in the direction of the arrows.

FIG. 5B is an enlarged cross section taken along line 5B-5B of FIG. 5A, looking downward.

FIG. 5C is an enlarged cross section taken along line 5C-5C of FIG. 5A, looking downward.

FIG. 6A is a sectional view similar to FIG. 5A, with some of its components alternately disposed.

FIG. 6B is sectional view similar to FIGS. 5A and 6A, with another alternate disposition of its components.

FIG. 6C is an enlarged sectional view similar to FIG. 5B, with an alternate disposition of its components.

FIG. 6D is an enlarged cross section taken along line 6D-6D in FIG. 6A.

FIG. 6E is an enlarged cross section taken along line 6E-6E in FIG. 6B.

FIG. 7 is a sectional view similar to FIGS. 5A, 6A and 6B, with yet another alternate disposition of its components.

FIG. 7A is a fragmentary sectional view similar to FIG. 7, showing an alternate disposition of one of the components.

FIG. 7B is an enlarged cross section similar to FIGS. 5B and 6C, with another alternate disposition of its components.

FIG. 7C is a sectional view taken along line 7C-7C in FIG. 7;

FIG. 7D is a sectional view taken along line 7D-7D in FIG. 7A;

FIG. 8 is a front view, showing a major component being disassembled.

FIG. 8A is a cross section showing 3 alternate positions, taken along line 8A-8A in FIG. 8;

FIG. 9A is a fragmentary sectional view showing another embodiment of the discharge area, in the “closed” position.

FIG. 9B is similar to FIG. 9A, except shown in the “open” position.

FIG. 9C is a cross section taken along line 9C-9C in FIG. 9A.

REFERENCE NUMERALS IN DRAWINGS

| | |
|---|---|
| 10 | entire device, assembled |
| 11 | upper tube end (exit) |
| 12 | tubular extension fitting (hose) |
| 14 | vacuum hose, portable |
| 15 | lower tube end (intake) |
| 16 | extension tube |
| 18 | floor nozzle |
| 20 | crevice tool |
| 22 | tapered extension wand |
| 22a | flexible extension (small hose) |
| 24a | short extension |
| 24 | brush |
| 26a | central vacuum system |
| 26b | canister type vacuum cleaner |
| 26c | upright vacuum cleaner |
| 28 | vacuum manifold |
| 28a | connector, manifold |
| 29 | vacuum source |
| 30 | vacuum hose, car wash |
| 32 | tube (main member) |
| 34 | hub |
| 36 | filter element |
| 36a | filter element, alternate |
| 38 | jar |
| 38a | jar, alternate |
| 40 | discharge plate |
| 40a | seal ring |
| 42 | captured articles |
| 44 | air exit aperture |
| 46 | first re-entry aperture |
| 48a | second re-entry aperture |
| 48b | second re-entry aperture |
| 48c | second re-entry aperture |
| 48d | second re-entry aperture |
| 50 | plug |
| 52 | screw |
| 54 | curved surface |
| 58 | flange |
| 60 | pin |
| 62 | slot, twist lock |
| 64 | integral bottom |
| 64a | integral bottom, alternate |
| 66 | hub portion |
| 66a | hub portion, alternate |
| 68 | orifice |
| 68a | orifice, alternate |
| 70 | opening |
| 72 | retaining ring |
| 74 | groove |
| 76 | lip |
| 78 | coarse filter hole pattern |
| 80 | medium filter hole pattern |
| 82 | fine filter hole pattern |
| 84 | full open filter aperture |
| 86 | annular opening |
| 88 | bent tab |
| 90 | hole |
| 92 | lever |
| 94 | pin |
| 96 | compression spring |
| 98 | extended tab |
| 100 | pocket, on hub |
| 102 | pocket, on lever |
| 104 | protruding part of lever |
| 106 | beveled protrusion |
| 108 | groove |
| 110 | inside edge |
| 112 | area of contact |
| 114 | bevel shaped depressions |
| 116 | vicinity of numerals |
| 118 | window |
| 120 | point to depress lever |
| 122 | stop ring |
| 124 | groove |
| 126 | wide undercut |
| 128 | narrow air slots |
| 130 | collar, air volume control |
| 132 | flow path arrow: coarse |
| 134 | flow path arrow: medium |
| 136 | flow path arrow: fine |
| 138 | flow path arrow, reverse |

### DESCRIPTION OF THE PREFERRED EMBODIMENT

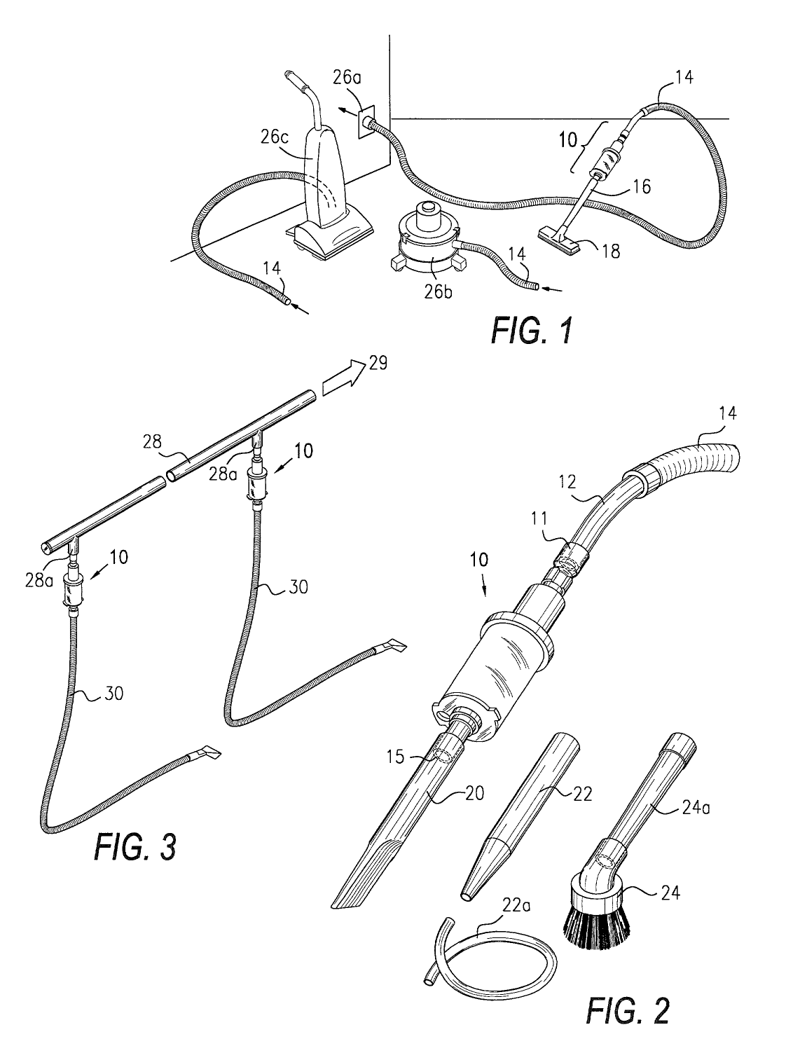

Referring now to the drawings, FIGS. 1 and 2 show a capturing device 10 according to this invention, connected at its upper end 11 to a tubular extension fitting 12 of a flexible vacuum hose 14, and at its lower end 15 to one of a variety of vacuum intake tools, here partially represented by an extension tube 16, a floor nozzle 18, a crevice tool 20, a tapered extension wand 22 with a flexible extension 22a, a short extension 24a and a brush 24. The connections consist of inserting the slightly tapered male end of one component into the equally tapered female receptacle of the other, causing a snug friction fit for secure and leak proof positioning. Such tapered ends of substantially uniform diameter are common with most makes of vacuum cleaners and associated attachments available in the marketplace, thus making this invention compatible with all of them. Of course, where other dimensional standards prevail, such as metric vs. non-metric, corresponding modifications are easily made.

By way of example, FIG. 1 shows the device 10 connected to, among others, a central vacuum system 26a, a portable canister type 26b, or an upright type 26c. There is no limit whatsoever on the type of vacuum system that can be utilized. Even wet applications present no problem other than the possible need for subsequent cleaning of the device. Variations in suction force or air volume do not adversely effect the efficiency and operation of the device, however an optional regulating control (described later) can be provided to enhance usage in certain environments, or when retrieving more delicate, easily damaged items.

FIG. 3 shows how the invention is utilized with a type of vacuum system typically employed in commercial car wash establishments. A vacuum manifold 28 is in communication with a continuous vacuum source 29 and includes a number of integral connectors 28a, usually one or two per car bay. The upper receptacle 11 of device 10 is attached to the connector 28a, and a hose 30 connects to the lower end 15. For this application it is preferred to use more permanent connections in lieu of the tapered friction fit, such as threaded or snap-in types (not shown). And should the manifold connectors be horizontally oriented, instead of vertically as shown, a 90 degree elbow fitting is added to complete the connection (not shown).

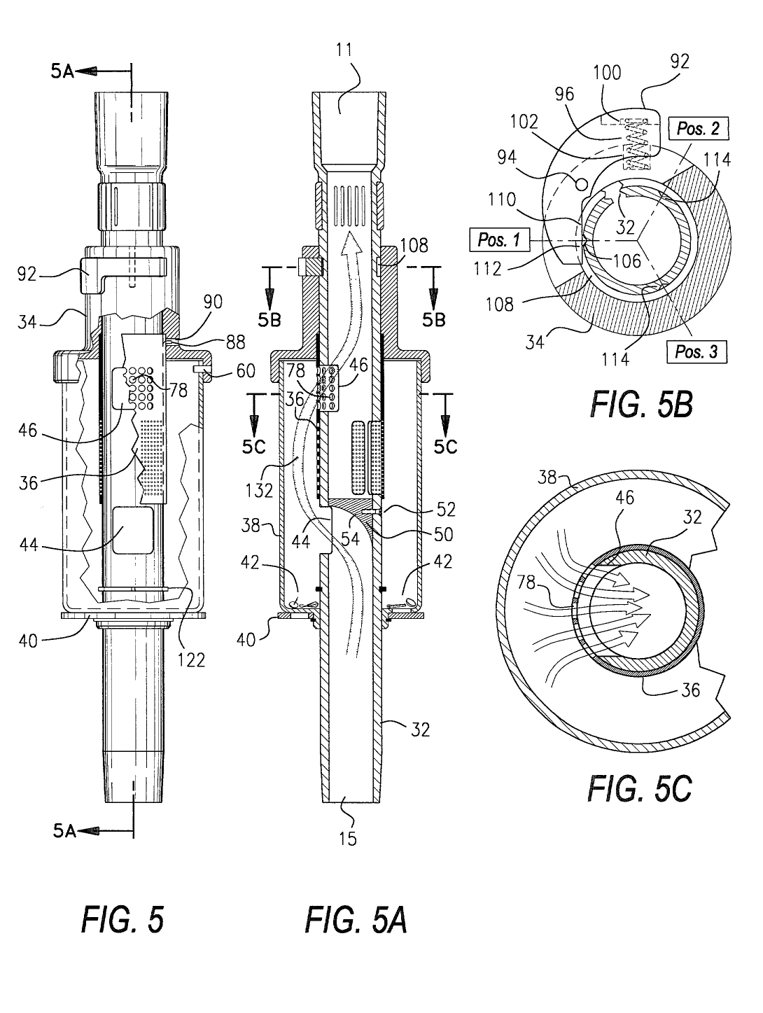

As shown in FIG. 5, the capturing device of this invention includes a tube 32, a hub 34, a filter element 36, a jar 38, a discharge plate 40, as well as fasteners and positioning components further described below. In addition to comprising the air inlet at its lower extremity 15, and the air outlet at its upper extremity 11, the tube 32 serves as the main structural member to which all other elements are mounted. At this point it is noted that the terms “upper” and “lower” are meant to relate to the orientation of the entire device as shown on the drawings, which for the most part is indeed the preferred orientation during vacuum operation, and particularly during the discharging of the captured articles 42, after the vacuum stream has been switched off. However, it is one of the advantages of this invention that during a vacuum search the device may be held in any desirable orientation, as necessitated by the search, whether vertical, horizontal, right side up or upside down.

Located near its medial region, the tube 32 incorporates an air exit aperture 44, a first re-entry aperture 46, and a group of second reentry apertures 48a, 48b, 48c, and 48d. Disposed fixedly inside of the tube 32 between the aperture 44 and the apertures 48a,b,c,d is a stationary plug 50 secured with a screw 52, incorporating a curved surface 54 that is facing aperture 44. Alternately, the plug 50 may be formed as an integral, contiguous part of tube 32, as may be contemplated if the tube is produced by injection molding. By obstructing the continual straight air path through the internal cylindrical passage formed by tube 32, plug 50 thus diverts the vacuum induced supply air stream, flowing from the inlet end 15 of tube 32, to a region encompassed by the jar 38, which surrounds the tube from a point substantially below aperture 44 to just above the upper edge of aperture 46. Thereupon the supply air re-enters tube 32 either through aperture 46, or through apertures 48a,b,c,d, depending on which one presents the largest open area. That in turn depends on the position of the filter element 36, which covers all the re-entry apertures 46 and 48 at all times.

The jar 38 is comprised of a see-through transparent plastic material in order to facilitate visual detection of all captured articles, and is engaged at its upper extremity with a flange 58 of the hub 34. It is held in place by a pin 60, which engages the jar near its rim via a twist lock slot 62, commonly known as a rifle lock. At its lower extremity, jar 38 defines an integral bottom 64 and a hub portion 66, whose inside diameter is just slightly larger than the diameter of tube 32 over which it fits, thus forming an effective seal between the atmosphere and the interior of jar 38, yet permitting free rotational and sliding movement of the jar with respect to tube 32. The bottom 64 incorporates an orifice 68, intended for discharging any captured articles 42 which accumulate inside the jar.

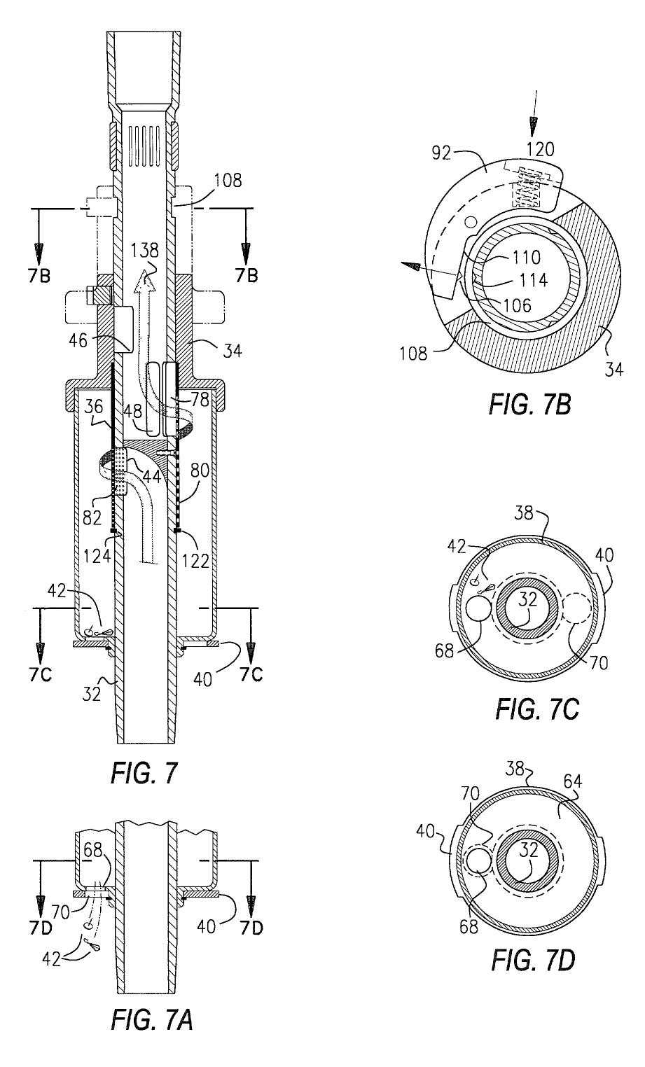

The discharge plate 40 fits rotatably over the outer diameter of the hub portion 66, and is secured by a retaining ring 72, which snaps into a groove 74. Plate 40 incorporates an opening 70, which aligns with the orifice 68 of jar 38 whenever it is rotated to the position shown in FIGS. 7A and 7D. This allows any captured article or articles 42 to be discharged without the necessity of removing the jar itself.

During normal vacuum operation, the discharge plate 40 is rotated so that the orifice 68 remains effectively covered and sealed against the atmosphere, as shown in FIG. 7C. Detent means (not shown) may be provided to aid in positioning the plate precisely.

In an alternate embodiment of this invention, the components provided for discharging captured articles are configured as shown in FIGS. 9A, 9B, and 9C:

The lower extremity of a jar 38a, otherwise identical to jar 38, defines a bottom 64a, which is inwardly inclined at an angle steep enough to cause captured articles to fall to its lowest level, when the device is held in an approximately vertical position after the vacuum flow has been turned off. The bottom 64a incorporates a plurality of orifices 68a equally spaced apart. The jar 38a also incorporates an extended hub portion 66a, whose inside diameter fits freely over tube 32. A V-shaped, dish like seal ring 40a fits snugly over the outside diameter of the hub portion 66a, held in position by moderate friction.

An integral lip 76 provides a bottom stop and prevents the seal ring 40a from slipping off. The angle of the seal ring 40a matches that of jar 38a. With the seal ring in its upper position (FIG. 9A), its orifices 68a are effectively sealed from the atmosphere. When captured articles are detected within jar 38a, vacuum is turned off, and seal ring 40a is slid to its lower position (FIG. 9B), allowing the captured articles 42 to fall into the dished rim for retrieval.

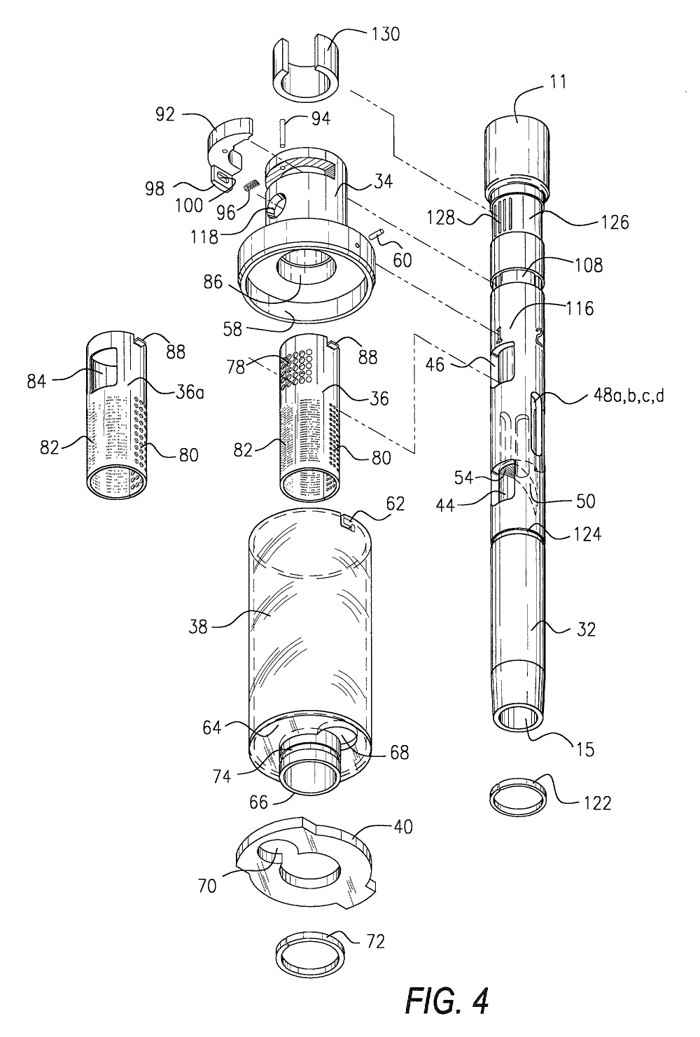

The filter element 36 defines a cylindrical shape, is comprised of sheet metal, and incorporates a series of three different hole patterns, each of which has a total free area equal to or greater than the area of the inside diameter of tube 32. The hole patterns are sized to provide a “coarse-medium-fine” range of filtering capabilities, indicated by 78, 80, and 82—or alternately, a “full open-medium-fine” capability provided by a filter element 36a, shown in FIG. 4 and denoted as 84, 80, and 82. The filter element is held fixedly within a concentric annular opening 86 of the hub 34, with a bent tab 88 protruding into a hole 90, thus holding it in angular and axial register with hub 34. Consequently, any motion and position change imparted upon the hub is duplicated by filter element 36. This assures that its various hole patterns always align as intended with the air path apertures of tube 32.

A lever 92 is mounted pivotably in the upper slot-like space of hub 34, retained by and pivoting about a pin 94. A compression spring 96 is disposed between the upper portion of hub 34 and an extended tab 98 of the lever 92, retained by a pocket 100 and a pocket 102, as shown in FIG. 5B. The spring 96 constantly presses the protruding part 104 of the lever 92 away from the center, thereby urging its opposite end, which incorporates a beveled protrusion 106, toward the center of tube 32.

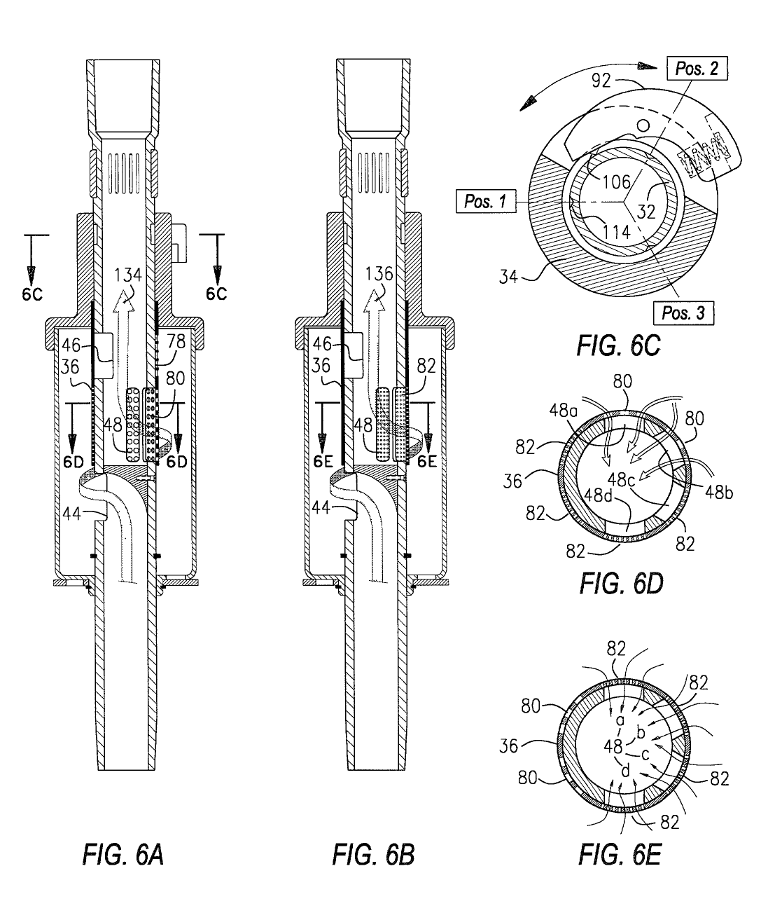

The hub 34, together with the filter element 36 or 36a, is slideably and rotatably fit over tube 32, as shown in FIG. 5A. In its normal longitudinal position, the lever 92 aligns with a groove 108 of tube 32, and an inside edge 110 of lever 92 engages with the groove 108 at a contact area denoted by 112, due to being urged towards it by the force of spring 96. This assures that hub 34 is restrained against any longitudinal movement with respect to tube 32, i.e. any movement parallel to their common axis. The center bore of hub 34 and the inside surface of the cylindrical filter element 36 are of the same diameter, which is just slightly larger than the outside diameter of tube 32, thus forming an effective seal between the various air passages 44, 46 and 48 of the tube, while at the same time allowing the hub and the filter element to be freely rotated in either direction. The groove 108 incorporates three bevel shaped depressions 114 similar in profile to the beveled protrusion 106, which are equally spaced around the groove's perimeter, and extend across its width. As hub 34 is rotated, protrusion 106 will engage with the first of the depressions it encounters, resulting in a positive detent stop. Rotating hub 34 in either direction, using only moderately increased force, will automatically disengage protrusion 106, in order to advance to another position (See FIG. 6C). In this manner, three discrete angular detent positions are attainable when rotating hub 34 about tube 32, while at the same time maintaining its longitudinal position, as indicated in FIG. 5B. Each of the 3 positions will provide the operator with a different filtering capability:

### Position 1

If equipped with the filter element 36, the device will capture any article larger than the hole diameter of a “coarse” hole pattern 78, while allowing almost all normal debris, lint etc. encountered in the process to pass on through. If equipped with an alternate filter element 36a, this position is full open, permitting everything to pass through unhindered. See FIG. 4, showing the filter element 36a, which incorporates an aperture 84 equal in size to aperture 44 of tube 32. Therefore, while providing a needed convenience, position 1 is to be used with the greatest caution.

### Position 2

Will capture any article larger than the hole diameter of a “medium” hole pattern 80, while still allowing fine dust, smaller granules and pieces of debris to pass through. Some lint, hair and other debris may slowly accumulate during extended search periods.

### Position 3

Will capture any article as tiny as the hole diameter of a “fine” hole pattern 82, while still allowing fine dust and finer granules to pass on through. Larger debris will also accumulate, congregating more rapidly than in position 2. Position 3 requires more frequent checks for results, each followed by a quick “self cleaning” procedure.

To enable the operator to easily distinguish between the foregoing filter positions, the numerals 1,2,3 are inscribed bright and highly visible on the exterior of tube 32 in a vicinity 116 covered by hub 34. A window 118 in hub 34 is placed so as to align itself with the appropriate numeral whenever any one of the three detent positions is in engagement.

Referring to FIG. 7B, when the lever 92 is depressed near a point 120, its opposite end moves away from detent depression 114, and if fully depressed, the edge 110 and the protrusion 106 will completely clear groove 108 so as to release hub 34 from its longitudinal restraint with tube 30. Thus hub 34 with its integral filter element 36 can slide downward until the lower extremity of the filter element makes contact with a stop ring 122, which is fixed in position on tube 32 in a groove 124. See FIG. 7. When in this position, hub 34 may be freely rotated through 360 degrees in either direction. As will be explained under “Operation”, this filter position is used for self-cleaning of the capturing device.

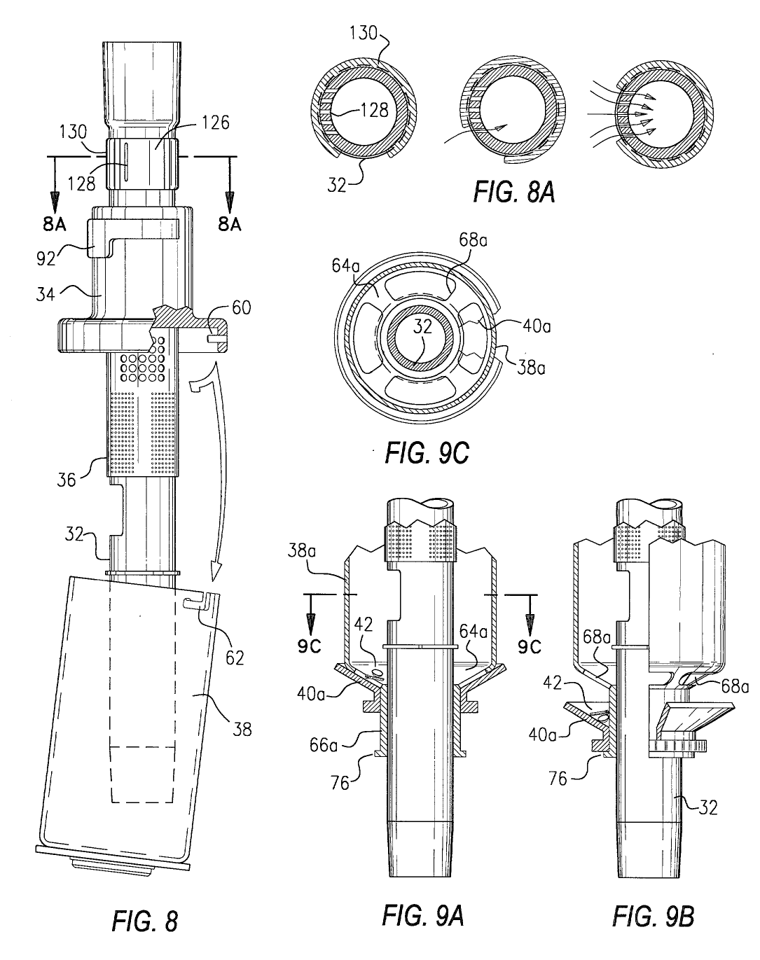

Referring to FIG. 8, the upper portion of tube 32 incorporates a wide undercut 126, whose diameter is just slightly less than the tube outside diameter. A series of narrow, adjacent slots 128 pierce the tube wall within the confines of the undercut. A collar 130, substantially cylindrical in shape, but with part of its circumference removed, and having an inside diameter slightly smaller than the diameter of the undercut 126, fits snugly over it, held by friction in any desired angular position. With only slight force it can be rotated to any other position, so as to cover the slots 128 completely, partially or not at all, as illustrated in FIG. 8A. This comprises a “vacuum volume control”, to be elaborated upon subsequently.

### OPERATION

With the device connected to a vacuum source, and a suitable nozzle at its intake:

### Position 1

Assuming that a number of small fasteners, such as screws, nuts and washers are to be found and captured, any of which are known to be larger than the holes in the “coarse” pattern 78 of filter element 36, the operator rotates hub 34 until it clicks in position with the numeral “1” in window 118. This aligns the internal air passages as shown in FIG. 5A, and upon activating the vacuum source, air is immediately drawn from intake 15 through aperture 44 into jar 38, then through filter holes 78 and aperture 46 (See FIG. 5C) out through exit 11, as indicated by a flow path arrow 132. As a result, any article entrained in the air stream will be intercepted by filter element 36 if it is larger than holes 78, and pass through if it is smaller. Upon visual discovery, it is then discharged through orifice 68 as previously described.

### Position 2

If the lost article is smaller than hole pattern 78, the operator selects hub position 2 in window 118. The internal air passages are now aligned as shown in FIG. 6A, so that aperture 46 is now blocked by the solid portion of filter element 36, and the “medium” hole pattern 80 is aligned with apertures 48a and 48b, shown in FIG. 6D. This now constitutes the air path of least resistance, depicted by a flow path arrow 134. Anything larger than holes 80 will be captured within jar 38.

### Position 3

If the lost article is smaller still than the holes 80, or if its size is unknown, the safest selection to be made is hub position 3. This aligns the internal air passages as shown in FIGS. 6B and 6E, whereby aperture 46 is still blocked by the solid portion of filter element 36, and filter holes 80 are blocked by the solid portion of tube 32, so that the path of least resistance is now through the “fine” hole pattern 82, as depicted in FIG. 6B by a flow path arrow 136.

### Self-Cleaning

As was pointed out previously, it is inevitable that a certain amount of debris, lint, and other foreign matter is picked up during a search, especially in position 3, and to a lesser degree in position 2. This debris will collect for the most part on the surface of filter element 36, where it is easily examined all around the perimeter in order to check for the lost article. If the latter is not present, the debris may be purged from jar 38 within seconds, by simply rotating hub 34 to position 1. This immediately opens up the larger passages through hole pattern 78, and the resulting blast is usually sufficient to suck everything out of the area toward the vacuum source. During this process, discharge plate 40 can also be rotated so that its orifice 68 is at least partially open, which has the effect of purging any foreign matter from the lowermost zones of jar 38.

Under conditions where severe concentrations of debris are encountered, it is possible for some lint or fibers to cling more tenaciously to filter element 36, so that the above procedure cannot entirely remove them. This is easily remedied by depressing the lever 92 and lowering jar 38 to the position depicted in FIG. 7, whereby aperture 44 is now facing the interior surface of filter element 36, and the “coarse” hole pattern 78 is aligned with apertures 48a,b,c and d. This directs the air blast through the filter holes 82 and 80 in the reverse direction, as depicted in FIG. 7 by a flow path arrow 138. During this process, hub 34 can be freely rotated as well as incrementally moved in the longitudinal direction, so as to expose every portion of the filter's interior to the air stream in a form of “sweeping” action, until all foreign matter has been purged.

As a last resort, should the debris build-up inadvertently reach extreme conditions of crowding or compacting, the entire jar 38 is easily removed from hub 34 as depicted in FIG. 8. First, the vacuum is turned off, the intake nozzle is removed from tube end 15, then the jar is freed from pin 60 with a twisting motion, and slid off of tube 32.

### Vacuum Volume Control

In normal use, the collar 130 is disposed so as to fully cover the slots 128, which permits the maximum airflow delivery through the system, as depicted in FIG. 8A, left most detail. Where it is desired to diminish the air volume and velocity at the nozzle entry of the system, be it to avoid sucking in adjacent items which may tend to clog the entrance, or to use a more gentle air stream for picking up delicate articles, collar 130 is rotated as needed to allow more air to enter the system at that point. This will cause a corresponding airflow reduction at the nozzle entry.

The foregoing detailed description is illustrative of a particular embodiment of the invention, and it is to be understood that through changes and modifications additional embodiments may occur to those skilled in the art without departing from the spirit of the present invention. The embodiments described herein together with those additional embodiments are considered to be within the scope of the invention.

I claim:

1 A retrieval device for capturing and recovering small articles, operated by a moving air stream by adaptably connecting it to a vacuum cleaning system, said retrieval device comprising:
a rigid elongated annular air tube including a primary inlet opening, a medial region defining an intermediate air exit passage, internal diverting means cooperating with said intermediate air exit passage in re-directing the air stream, one or more air re-entry passages extended away from said intermediate air exit passage, and a final outlet opening, whereby the air stream enters said air tube at said primary inlet opening, flows toward said diverting means, exits said air tube through said intermediate air exit passage, re-enters through one or more of said air re-entry passages, then exits said retrieval device through said final outlet opening;
a hub mounted rotatably and slidably on said air tube, including positioning means, whereby said hub is continually held in a discrete first longitudinal position with respect to said air tube, while being free to rotate about its center through 360 degrees in either direction, said hub further including a circular portion extending radially outward with a flange at its distal perimeter, said circular portion and said flange defining the top closure of the next element;
a jar of substantially cylindrical shape, comprised of a translucent plastic material for providing a clear view of its contents, fixedly mounted at its upper extremity to said flange of said hub by means permitting manual removal, said jar including a bottom surface and a sleeve portion rotatably and slidably adapted to said air tube, whereas said jar forms a vacuum tight compartment surrounding said air tube in the area encompassing said intermediate air exit passage and said air re-entry passages, thereby enabling continual airflow between the said internal air
passages, whereby every object traveling within the air stream must traverse, at a minimum, the space within said jar between said intermediate air exit passage and said air re-entry passages;
a filter element, substantially cylindrical in shape, mounted fixedly to said hub, surrounding said air tube in close rotatable and slidable contact, said filter element including a multiplicity of filtering orifices of uniform size, and means bringing said filtering orifices into alignment with said air re-entry passages of said air tube whenever said hub is in said first longitudinal position, whereby the air stream exits said air tube through said intermediate air exit passage and re-enters it by first passing through said filtering orifices and second through said air re-entry passages, thereby causing objects transported by the air stream which are smaller than said filtering orifices to pass freely through, and causing objects larger than said filtering orifices to remain trapped within said jar between said filter element and said intermediate air exit passage;

2 the retrieval device of claim 1 wherein the aggregate of said air re-entry passages is radially disposed 180 degrees with respect to said intermediate air exit passage for causing the air stream to describe a cyclonic path, thereby inducing orbital motion of articles entrained in said air stream for enhanced recognition and for separation of those heavier than air by centrifugal force;

3 the retrieval device of claim 1 wherein the region inside said jar that is located between the bottom edge of said intermediate air exit passage and said bottom surface of said jar is of optimal dimensions, so as to comprise a region of lowest air turbulence, whereby the effects of separating heavier than air articles and settling them within said region are maximized;

4 the retrieval device of claim 1 wherein said region within said jar that is located between said bottom edge of said intermediate air exit passage and said bottom surface of said jar comprises a holding area whereby, after the vacuum air stream is turned off, captured articles are prevented from falling back out of said air tube through said intermediate air exit passage;

5 the retrieval device of claim 4 including releasable positioning means, whereas said hub is released from said first longitudinal position and free to move slidably to a second range of longitudinal positions defining a self-cleaning position range, in which said filter element substantially surrounds said air tube within the region occupied by said intermediate air exit passage and by said air re-entry passages, and further, wherein said filter element incorporates a full open air re-entry orifice extended away from said multiple filtering orifices, whereby the air stream exiting said air tube through said air exit passage flows through said multiple filtering orifices in the reverse direction, thereby dislodging residual debris having clogged said filtering orifices when said filter element was in said first longitudinal position, said air stream then completing its path through the interior of said jar, through said full open re-entry orifice of said filter element into one or more of said re-entry passages of said air tube and out through said final outlet opening, thereby removing all said debris and transporting it to said debris reservoir of said vacuum system;

6 the retrieval device of claim 5 including a stop ring fixedly attached to said air tube, whereby the lower extremity of said filter element is brought into contact with said stop ring to define a discrete third longitudinal position, in which all of said filter orifices and said air passages of said air tube are then in the most favorable alignment for said self-cleaning, aided by rotating said filter element freely through 360 degrees;

7 the retrieval device of claim 6 including means to discharge captured articles, wherein said jar incorporates a discharge orifice within the web portion of said jar bottom at an optimum radial distance from its center; said discharge means further including a flat, substantially disk-like discharge plate mounted rotatably to said sleeve portion of said jar, said discharge plate incorporating an aperture similar in size and radial position to said discharge orifice in said jar, said discharge plate having one of its surfaces in direct abutment with the external surface of said jar, whereas said discharge plate may be manually rotated to a radial position in which said aperture in said discharge plate is aligned with said discharge orifice of said jar, thereby allowing captured articles to be extracted from said retrieval device without removing said jar;

8 the retrieval device of claim 7 wherein said discharge plate includes detent means for precise positioning of said discharge plate in the full open position and in one or more closed positions.

9 the retrieval device of claim 7 wherein said discharge plate is comprised of transparent material and the bottom surface of said discharge plate includes a mirror coating, thereby making said captured articles appear as double images for enhanced recognition;

10 the retrieval device of claim 6 including alternate means for discharging captured articles, wherein said jar includes an inwardly inclined bottom surface having a plurality of discharge openings, and an elongated sleeve portion rotatably and slidably adapted to said air tube, a seal ring defining a circular cone shaped rim with a contiguous cylindrical bushing portion, whereas said cylindrical bushing portion mounts slidably over the outer surface of said elongated sleeve portion of said jar, and said cone shaped rim closely abuts the external surface of said inclined bottom portion of said jar, so as to completely cover said plurality of discharge openings and thus prevent egress and ingress when said seal ring is slidably disposed in a first closed position with respect to said elongated sleeve portion, yet permit full egress and ingress when said seal ring is disposed in a second open position, whereby said captured articles fall into and are temporarily retained by said cone shaped rim;

11 the retrieval device of claim 10 wherein said seal ring is comprised of transparent material and the bottom surface of said seal ring includes a mirror coating, thereby making said captured articles appear as double images for enhanced recognition;

12 the retrieval device of claim 1 including a flexible hose sized to permit clear passage of the article or articles to be retrieved, and of a length suitable to reach said articles in places of restricted access, adaptably mounted at the intake end of said air tube;

13 the retrieval device according to claim 1 including means to diminish the air volume and velocity at said primary inlet opening, comprising: an annular depression disposed adjacent to said final outlet opening of said air tube including a plurality of air inlet slots congregated on one side of said air tube within said annular depression, a cylindrical collar mounted in said annular depression in snug rotatable relation, said collar having part of its circumference removed to expose the entire said plurality of air inlet slots when in a first rotational position, and covering said plurality of air inlet slots one by one when rotated away from said first position to a second position disposed 180 degrees from the first so as to cover all of said air inlet slots, whereby air volume and velocity at said primary inlet opening is greatest with said collar rotated to said second position, and least when rotated to said first position;

14 a retrieval device for capturing and recovering small articles, operated by a moving air stream by adaptably connecting it to a vacuum cleaning system, said retrieval device comprising:
a rigid elongated annular air tube including a primary inlet opening, a medial region defining an intermediate air exit passage, internal diverting means cooperating with said intermediate air exit passage in re-directing the air stream, one or more air re-entry passages extended away from said intermediate air exit passage, and a final outlet opening, whereby the air stream enters said air tube at said primary inlet opening, flows toward said diverting means, exits said air tube through said intermediate air exit passage, re-enters through one or more of said air re-entry passages, then exits said retrieval device through said final outlet opening;
a hub mounted rotatably and slidably on said air tube, including first positioning means, whereby said hub is continually held in a discrete first longitudinal position with respect to said air tube, while being free to rotate about its center through 360 degrees in either direction, said hub also including second positioning means, whereby said hub is simultaneously held in a discrete first radial position with respect to said air tube, said second positioning means also providing for additional discrete radial positions of said hub for aligning multiple internal air passages, and said hub further including a circular portion extending radially outward with a flange at its distal perimeter, said circular portion and said flange defining the top closure of the next element;
a jar of substantially cylindrical shape, comprised of a translucent plastic material for providing a clear view of its contents, fixedly mounted at its upper extremity to said flange of said hub by means permitting manual removal, said jar including a bottom surface and a sleeve portion rotatably and slidably adapted to said air tube, whereas said jar forms a vacuum tight compartment surrounding said air tube in the area encompassing said intermediate air exit passage and said air re-entry passages, thereby enabling continual airflow between the said internal air passages, whereby every object traveling within the air stream must traverse, at a minimum, the space within said jar between said intermediate air exit passage and said air re-entry passages;
a multiple filter element, substantially cylindrical in shape, mounted fixedly to said hub, surrounding said air tube in close rotatable and slidable contact, said multiple filter element including two or more filtering zones, whereby one zone incorporates a multiplicity of filtering orifices of one uniform size, the next zone incorporates a multiplicity of filtering orifices of another uniform size etc., combined with means for bringing certain of said filtering zones into alignment with certain of said air re-entry passages of said air tube whenever said hub is in said first longitudinal position and in one of said discrete radial positions, whereby the air stream exits said air tube through said intermediate air exit passage and re-enters it by passing through the largest of said filtering orifices that are in alignment with said air re-entry passages by virtue of having selected the corresponding one of said discrete radial positions, thereby causing objects transported by the air stream which are smaller than said filtering orifices to pass freely through, and causing objects larger than said filtering orifices to remain trapped within said jar between said filter element and said intermediate air exit passage;

15 the retrieval device according to claim 14, whereby said second positioning means comprise a detent mechanism for precise radial alignment of said internal passages in each position;

16 the retrieval device of claim 15, including visual indicating means for displaying suitable signage representing each of said discrete radial positions of said hub when hub is stopped in said radial position by said detent mechanism;
